(19) United States
(12) Patent Application Publication
(10) Pub. No.: US 2012/0033907 A1
(43) Pub. Date: Feb. 9, 2012

(54) ROLLER BEARING

(76) Inventors: Matthias Huhnke, Kisslegg (DE); Andreas Schaefer, Leutkirch (DE); Bernhard Boeck, Immenstadt (DE)

(21) Appl. No.: 13/186,706

(22) Filed: Jul. 20, 2011

(30) Foreign Application Priority Data
Aug. 7, 2010 (DE) 10 2010 034 216.5

(51) Int. Cl. F16C 33/66

(52) U.S. Cl. 384/473; 384/462

(57) ABSTRACT

The invention relates to a roller bearing having an inner bearing ring having a raceway and an outer bearing ring having a raceway and a plurality of rolling elements disposed between the raceways that are lubricated by a lubricant. The invention is characterized in that the surface of the inner bearing ring and/or of the outer bearing ring facing the rolling elements and/or the surface of a cage holding the rolling elements have a surface structure.

### BACKGROUND OF THE INVENTION

The invention relates to a roller bearing, such as a ball bearing or a roller bearing, according to the preamble of claim 1.

### DESCRIPTION OF THE PRIOR ART

The functional surfaces of roller bearings are generally ground, and where necessary honed, with great precision, it being necessary for the surfaces thus formed to be provided with specific roughness and waviness. When the raceways are honed, the main aim is to create lubricant reservoirs using cross-grinding in order to ensure the necessary lubricating film is existing between the ball and the raceway.

Due to centrifugal forces and external influences, for example differences in pressure, the lubricant in roller bearings is transported to undefined areas and is then lacking at the required lubrication points such as ball/roller to the cage or raceway and cage to the inner or outer rings. This could result in a shortening of the operating life of the roller bearing or/and in greater variability in the operating life of the individual bearing within a production series.

In practice, this problem particularly arises for extremely fast rotating roller bearings, as used, for example, to support a compressed air turbine drive of a dental drill or to support the blade wheels in turbochargers. Specifically, the problem for dental turbines, for example, lies in the fact that the lubricant can be forced out of the bearing by the compressed air, or that the lubricant collects within the bearing in areas unfavorable for the bearing due to centrifugal forces. Moreover, dental turbines are regularly disinfected in a disinfectant solution, thus also causing lubricant to be rinsed out of the roller bearing. After disinfection, the roller bearing is re-lubricated in an undefined manner. Although this action does supply the bearing with fresh lubricant, the lubricant does not necessarily reach the areas in the roller bearing needing lubrication.

### SUMMARY OF THE INVENTION

It is the object of the invention to improve a roller bearing with regard to the distribution of lubricant.

This object has been achieved according to the invention by a roller bearing having an inner bearing ring having a raceway and an outer bearing ring having a raceway and a plurality of rolling elements disposed between the raceways that are lubricated by a lubricant, wherein the surface of the inner bearing ring and/or of the outer bearing ring facing the rolling elements and/or the surface of a cage holding the rolling elements has a surface structure.

Further, a method for lubricating a roller bearing is described, wherein a lubricant for maintaining a lubricating film between a raceway of an inner bearing ring, a raceway of an outer bearing ring and a plurality of rolling elements is introduced, wherein, when the bearing is in operation, the lubricant is actively transported into the region of at least one raceway by using surface structures that are disposed on the surfaces of the inner bearing ring and/or of the outer bearing ring facing the rolling elements and/or a surface of a cage holding the rolling elements.

Preferred embodiments of the invention and further advantageous characteristics are outlined in the dependent claims.

Through appropriate, intended and controlled structuring of the surfaces of the bore of the outer ring or of the outside diameter of the inner ring, as well as potentially parts of the raceways or of the cage, the direction in which the lubricant is transported between the ring and the cage, as well as the ball and raceway, can be influenced to the desired extent. The surfaces can be structured by means of laser ablation, an electrochemical erosion process, forming or a cutting process. The shape and depth of the surface structure can be varied according to the future rotational speed of the roller bearing in order to influence the amount of lubricant that is to be transported.

According to the invention, surfaces of the inner and/or outer ring facing the cage or surfaces of the cage are provided with surface structures that, during operation of the roller bearing, generate a kind of pumping effect on the lubricant. These surface structures preferably consist of contradirectional grooves shaped like screw threads or spiral-shaped grooves. The thread-like or spiral grooves extend inwards from the axial end of the respective bearing ring in the direction of the raceway for the rolling elements. The thread-like or spiral grooves may end directly in the raceway up to or in the area of contact of the ball, or in a groove acting as a reservoir in a region beside the raceways. The balls then take up lubricant from this area and transport it to the ball cage and even to the other bearing ring. It is understood that in this arrangement, the roller bearing can only be operated in one specific rotational direction, otherwise the lubricant would be transported outwards away from the raceways to the edge of the bearing rings.

The respective grooves may also be designed as grooves with a herringbone structure or suchlike, where the number of grooves, their angle, depth and width all act as variables so as to generate a desired pumping effect, depending on the rotational speed and the size of the roller bearing and of course the properties of the lubricant. The grooves may be formed, for example, by laser ablation, a cutting process, forming or ECM and have a preferred depth of about 3 micrometers to about 50 micrometers and a preferred width of 10 to 400 micrometers.

The invention is described in more detail below on the basis of a preferred embodiment with reference to the drawings. Further characteristics and advantages of the invention can be derived from the drawings and the following description.

### BRIEF DESCRIPTION OF THE DRAWINGS

FIG. 1 shows a partial section through a roller bearing according to the invention.

FIG. 2 shows a partial section through a roller bearing according to the invention, having a cage.

FIG. 3 shows a view from above onto the outer surface of the inner bearing ring.

FIG. 3A shows a view from above onto the outer surface of the inner bearing ring according to a further embodiment of the present invention.

FIG. 4 shows a view from above onto the outer surface of the inner bearing ring having an outer, circumferential groove.

FIG. 5 shows a view from above onto the outer surface of the inner bearing ring, where the structure ends in the curvature of the raceway.

FIG. 6 shows a cage having a surface structure.

### DESCRIPTION OF PREFERRED EMBODIMENTS OF THE INVENTION

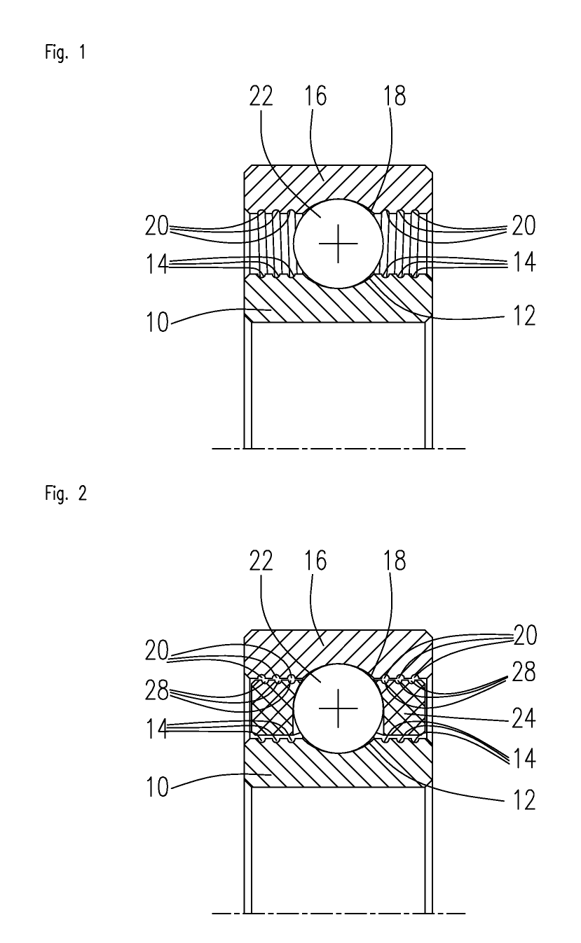

In FIG. 1, a partial section through a grooved ball bearing as can be used according to the invention is illustrated. However, the invention is not restricted to grooved ball bearings, but may be realized using all kinds of roller bearings, such as ball bearings, roller bearings or needle bearings.

The ball bearing from FIG. 1 comprises an inner bearing ring 10 as well as an outer bearing ring 16, each having raceways 12, 18 between which a plurality of rolling elements 22 taking the form of balls are disposed. The balls 22 are generally held in position with respect to one another by a ball cage that is not illustrated here. A ball cage is not absolutely necessary for the invention if a structuring of the raceway itself is sufficient for the transport of lubricant.

The contact surfaces between the raceways 12, 18 and the balls 22 or between the balls 22 and the ball cage respectively are lubricated with a lubricant, such as oil or grease having an appropriate viscosity so as to reduce friction resistance and material wear and to increase the operating life of the ball bearing. When the ball bearing is in operation, the lubricant is distributed in an undefined manner due to differences in pressure and centrifugal forces and a part does not reach the areas needing lubrication.

According to the invention, provision is made for the circumferential surfaces facing each other of the inner bearing ring 10 and/or of the outer bearing ring 16 and/or of the raceways 12, 18 of one or both rings of the bearing to be provided with a surface structure 14, 20. In FIG. 1, all the surfaces facing each other of both bearing rings 10, 16 with the exception of the raceways 12, 18 are provided with a surface structure 14, 20. However, the invention also includes embodiments in which only the surface of the inner bearing ring 10 or the corresponding surface of the outer bearing ring 16 facing in the direction of the balls 22 is provided with surface structures 14, 20. Moreover, it is possible to provide both the surfaces on the left-hand with respect to the illustrated ball 22 as well as the right-hand surfaces of the bearing rings 10, 16 with surface structures, or only the left-hand surfaces or the right-hand surfaces of both bearing rings 10, 16 or even only one left-hand or right-hand surface of one or both bearing rings.

In the illustrated embodiment, the surface structures 14, 20 take the form of helical grooves that extend thread-like from the outer ends of the bearing rings 10, 16 in the direction of the balls 22 up to the raceways 12, 18.

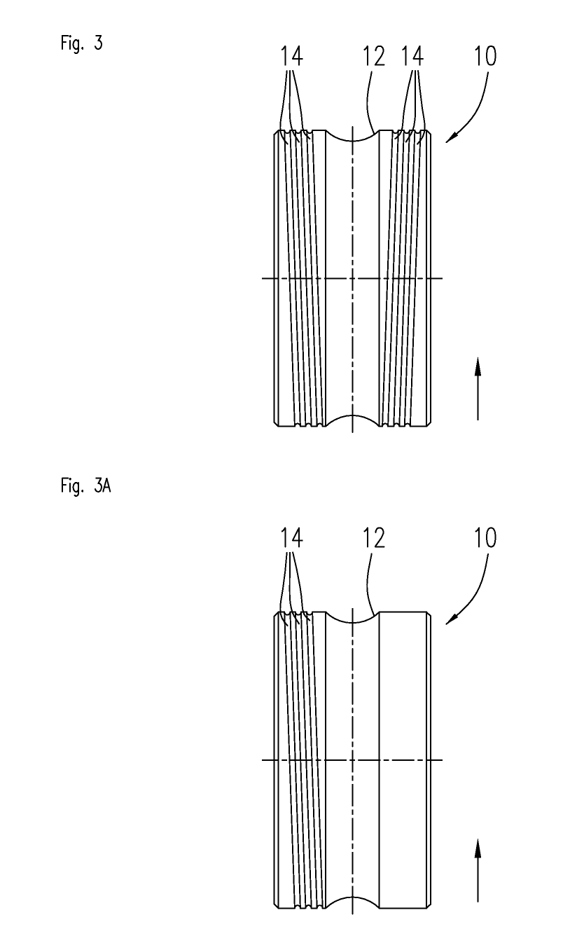

FIG. 2 shows a partial section through a roller bearing according to the invention having a cage 24, where the structure 14, 20 provided according to the invention may be located on the bearing rings 10, 16 and/or structures 28 may be provided on the surfaces of the cage.

FIG. 3 shows a view from above onto the inner bearing ring 10, where the raceway 12 for the balls 22 can be seen as well as appropriate grooves 14 to the left and right of the raceway. The grooves 14 are so disposed that when the bearing is in operation, in which both the bearing rings as well as the balls move with respect to one another, they apparently run inwards in the direction of the raceway 12. Through the apparent screwing motion of the grooves 14 directed inwards in the direction of the raceway 12, any lubricant found on the surface of the bearing ring 10 is then carried up and transported inwards and reaches the region of the raceway 12. Here, it is important that the direction of rotation of the roller bearing (the relative direction of rotation of the inner ring is indicated by the arrow) is aligned to the geometry of the grooves 14, so as to ensure that an inwardly directed lubricant transport effect in the direction of the raceway 12 is produced and not one directed towards the outside.

FIG. 3A shows a view from above onto the outer surface of the inner bearing ring according to a further embodiment of the present invention. Here, appropriate grooves 14 are only provided on one side of the raceway 12. This modification is particularly suitable for drives in which the drive is realized using compressed air so that compressed air flows through the bearing from a side in opposition to the direction of transport of the grooves. For example, in the case of dental hand pieces operated by air turbines, when compressed air is introduced to drive the turbine, air flows through the bearing in one direction, where particularly high-speed air turbines, those operating at high rotational speeds of about 200,000 to 500,000 rpm, profit from a corresponding transportation effect of the lubricant in the opposite direction to the flow of compressed air due to the geometry of the grooves.

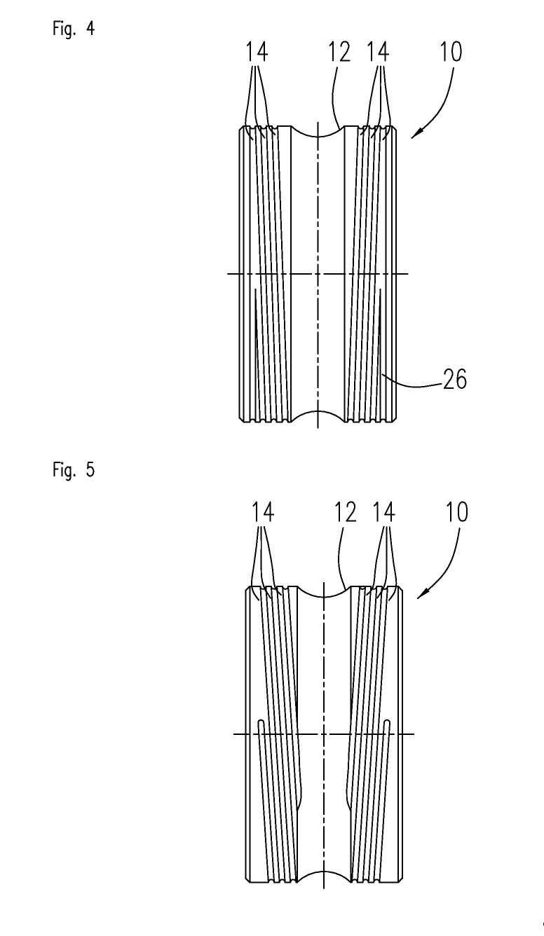

FIG. 4 shows a view from above onto the outer surface of the inner bearing ring 10 according to FIG. 3. The surface of the bearing ring 10 is provided with an outer, circumferential groove 26. Here, lubricant is transported from this groove 26 via the grooved structures 14 provided according to the invention to the region of the raceway 12 and the rolling elements running within the raceway 12.

FIG. 5 shows a view from above onto the outer surface of the inner bearing ring 10 according to FIG. 3, where the grooved structures 14 end in the region of curvature of the raceway 12.

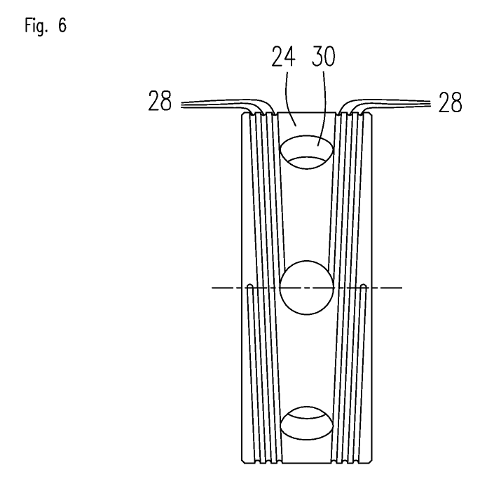

FIG. 6 shows a cage 24 having a grooved structure 28 provided according to the invention on its outer surface. The grooved structure 28 can preferably end in the recesses 30 for the rolling elements. Here, structure elements may be provided on individual or on a plurality of sections of the surface.

The grooves 14, 20, 26, 28 may be formed in the surface of the bearing rings 10, 16 or of the cage 24 either by a cutting process, laser ablation, deformation or an electrochemical erosion process. The depth of the grooves 14, 20, 26, 28 is, for example, 3 to 50 micrometers and depends substantially on the rotational speed of the roller bearing as well as its size and the viscosity of the lubricant. The width of the grooves 14, 20, 26, 28 as well, and the distance and the gradient of the spiral grooves 14, 20, 28 are dependent on the above-mentioned parameters of the roller bearing.

Separate grooves (FIG. 4) may moreover be disposed at the edges of the raceways 12, 18, the grooves 14, 20 ending in these separate grooves. These additional grooves act as a reservoir for the lubricant that collects there. The surface structures are preferably disposed where the ball cage is guided through the corresponding bearing ring, so as to additionally reduce the friction of the cage and ring. When the structures are disposed opposite the guide surface, the structures are used solely to transport the lubricant. The variant chosen depends on the bearing requirements.

Using a known method, the bearing rings may have appropriate sealing means (not illustrated) at their outer edges to seal the bearing and to prevent any lubricant from leaking out of the bearing.

### IDENTIFICATION REFERENCE LIST

10 Inner bearing ring
12 Raceway
14 Grooves
16 Outer bearing ring
18 Raceway
20 Grooves
22 Rolling element
24 Cage
26 Outer groove
28 Grooves on the cage
30 Recesses for rolling elements

1. A roller bearing having an inner bearing ring (10) having a raceway (12) and an outer bearing ring (16) having a raceway (18) and a plurality of rolling elements (22) disposed between the raceways that are lubricated by a lubricant, characterized in that
the surface of the inner bearing ring (10) and/or of the outer bearing ring (16) facing the rolling elements (22) and/or the surface of a cage (24) holding the rolling elements has a surface structure (14; 20, 26, 28).

2. A roller bearing according to claim 1, characterized in that the surface structure (14; 20, 26, 28) is designed such that when the roller bearing is in operation, the lubricant is transported in the direction of the raceways (12; 18) of the rolling elements (22).

3. A roller bearing according to claim 1, characterized in that the surface structure (14; 20, 26, 28) is disposed outside the raceways (12; 18) of the rolling elements (22).

4. A roller bearing according to claim 1, characterized in that the surface structure consists of grooves (14; 20, 26, 28) that are disposed on the outside circumference of the inner bearing ring (10) and/or on the inside circumference of the outer bearing ring (16) and/or on the outside circumference of the cage (24) and/or on the inside circumference of the cage (24).

5. A roller bearing according to claim 4, characterized in that the grooves (14; 20, 28) are shaped like the thread of a screw or spiral-shaped.

6. A roller bearing according to claim 4, characterized in that the grooves (14; 20, 28) extend inwardly from the axial ends of the respective bearing ring (10; 16) in the direction of the raceway (12; 18).

7. A roller bearing according to claim 4, characterized in that the grooves (14; 20, 28) end directly in the raceway (12; 18).

8. A roller bearing according to claim 4, characterized in that the grooves (14; 20, 28) end in a groove (26) acting as a reservoir for the lubricant.

9. A roller bearing according to claim 4, characterized in that the depth of the grooves (14; 20, 26, 28) is about 3 to 50 micrometers.

10. A roller bearing according to claim 1, characterized in that the surface structure (14; 20, 26, 28) is produced using a cutting process, a laser process, forming or an electrochemical erosion process.

11. A method for lubricating a roller bearing, wherein a lubricant for maintaining a lubricating film between a raceway (12) of an inner bearing ring (10), a raceway (18) of an outer bearing ring (16) and a plurality of rolling elements (22) is introduced, characterized in that
when the bearing is in operation, the lubricant is actively transported into the region of at least one raceway (12; 18) by using surface structures (14, 20, 26, 28) that are disposed on the surfaces of the inner bearing ring (10) and/or of the outer bearing ring (16) facing the rolling elements (22) and/or a surface of a cage (24) holding the rolling elements (22).
